(19) United States
(12) Patent Application Publication
(10) Pub. No.: US 2023/0027115 A1
(43) Pub. Date: Jan. 26, 2023

(54) EVENT-BASED RECORD MATCHING

(71) Applicant: INTERNATIONAL BUSINESS MACHINES CORPORATION, ARMONK, NY (US)

(72) Inventors: Geetha Sravanthi Pulipaty, Bangalore (IN); Soma Shekar Naganna, Bangalore (IN); Neeraj Ramkrishna Singh, Bangalore (IN); Abhishek Seth, Deoband (IN); James Albert O'Neill, Jr., Austin, TX (US)

(21) Appl. No.: 17/443,342

(22) Filed: Jul. 26, 2021

(51) Int. Cl. G06F 16/245

(52) U.S. Cl. CPC G06F 16/245

(57) ABSTRACT

A method, a structure, and a computer system for event-based record matching. The exemplary embodiments may include extracting one or more events from a first record and a second record, as well as calculating an event-based score based on comparing the one or more events extracted from the first record with the one or more events extracted from the second record. The exemplary embodiments may further include matching the first record to the second record based on the event-based score exceeding a threshold.

### BACKGROUND

The exemplary embodiments relate generally to record matching, and more particularly to event-based record matching.

Master Data Management (MDM) solutions work with enterprise data to index, match, and link data from different sources, creating a 360 view of customer data. Matching record pair data requires comparing different record attributes (e.g., name, address, DOB, identifier, etc.) from each pair of records to determine if they match, and should subsequently be linked, based on a series of mathematically derived statistical probabilities and complex weight tables.

MDM solutions typically involve obtaining data from different sources and applying matching algorithms across the critical parts of the data to determine whether they correspond to a same entity. This task traditionally involves comparing only the demographic attributes that are available within the sources of that enterprise, however problems with this approach include trying to identify an entity in its entirety by only looking at some attributes such as name/address/identifier, etc., as well as an inability to associate the related entities for the deduplication.

### SUMMARY

The exemplary embodiments disclose a method, a structure, and a computer system for event-based record matching. The exemplary embodiments may include extracting one or more events from a first record and a second record, as well as calculating an event-based score based on comparing the one or more events extracted from the first record with the one or more events extracted from the second record. The exemplary embodiments may further include matching the first record to the second record based on the event-based score exceeding a threshold.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a record matching system 100, in accordance with the exemplary embodiments.

FIG. 2 depicts an exemplary flowchart 200 illustrating the operations of a record matching program 122 of the record matching system 100, in accordance with the exemplary embodiments.

FIGS. 3A-C and 4A-C depict example use cases of the record matching program 122, in accordance with the exemplary embodiments.

FIG. 5 depicts an exemplary block diagram depicting the hardware components of the record matching system 100 of FIG. 1, in accordance with the exemplary embodiments.

FIG. 6 depicts a cloud computing environment, in accordance with the exemplary embodiments.

FIG. 7 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

Master Data Management (MDM) solutions work with enterprise data to index, match, and link data from different sources, creating a 360 view of customer data. Matching record pair data requires comparing different record attributes (e.g., name, address, DOB, identifier, etc.) from each pair of records to determine if they match, and should subsequently be linked, based on a series of mathematically derived statistical probabilities and complex weight tables.

MDM solutions typically involve obtaining data from different sources and applying matching algorithms across the critical parts of the data to determine whether they correspond to a same entity. This task traditionally involves comparing only the demographic attributes that are available within the sources of that enterprise, however problems with this approach include trying to identify an entity in its entirety by only looking at some attributes such as name/address/identifier, etc., as well as an inability to associate the related entities for the deduplication.

Trusted data is available from various untraditional sources and events are generated for every important action and activity of an entity. The present invention captures and uses this data in enhancing and improving the record matching process. In a use case, for example, improving the matching process is desirable because not only will it provide a better 360 degree view of an entity in a faster and real time manner, but it will also reduce costs associated with manual steward tasks for deduplicating records.

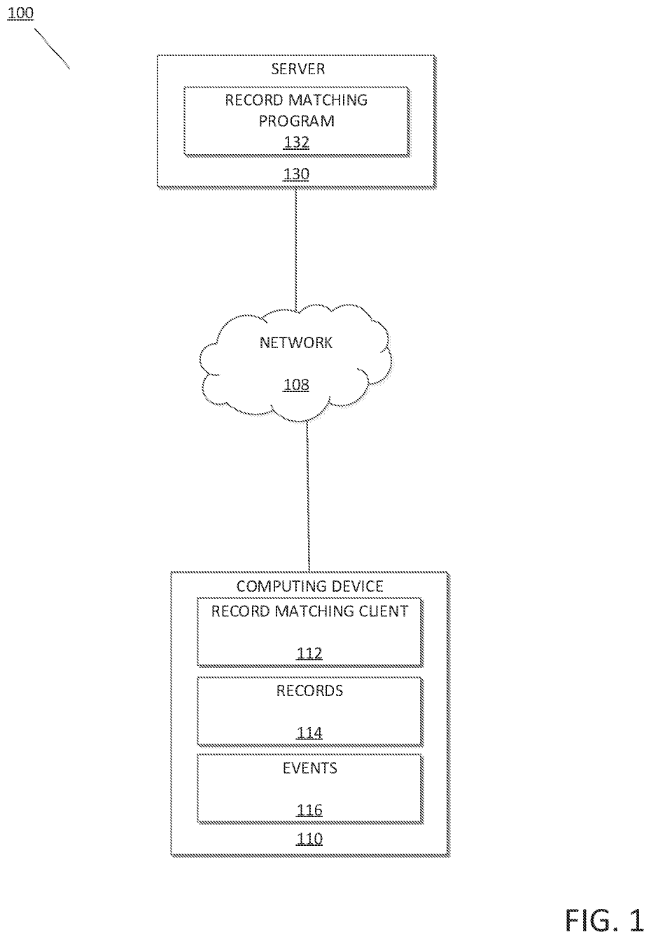

FIG. 1 depicts the record matching system 100, in accordance with exemplary embodiments. According to the exemplary embodiments, the record matching system 100 may include a computing device 110 and a record matching server 120, which all may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc., which may be implemented as an intranet network, a local area network (LAN), a wide area network (WAN), or a combination thereof. In further embodiments, the network 108 may be a Bluetooth network, a Wi-Fi network, or a combination thereof. The network 108 may operate in frequencies including 2.4 GHz and 5 GHz internet, near-field communication, Z-Wave, Zigbee, etc. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

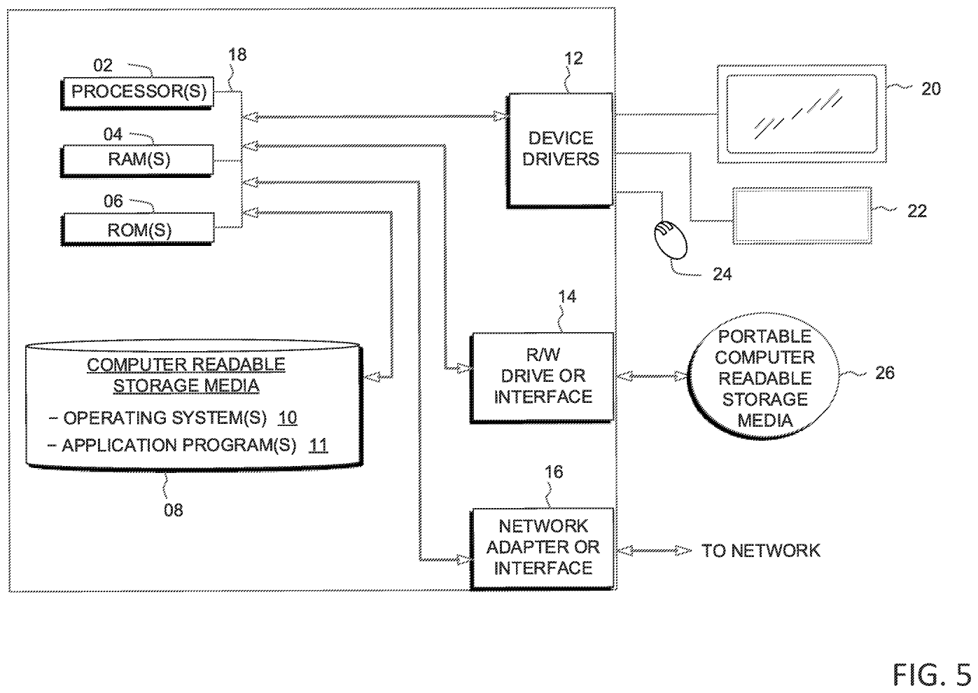

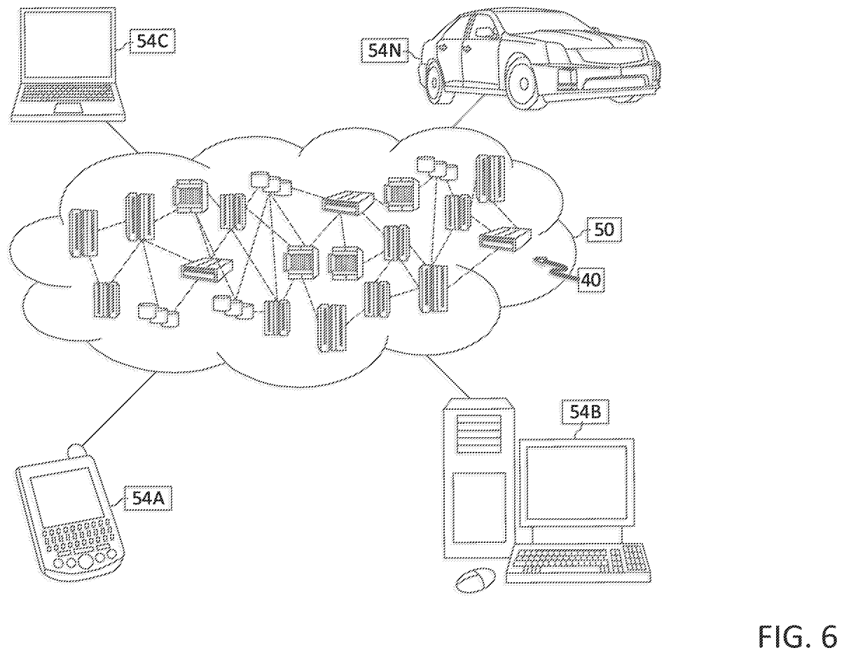

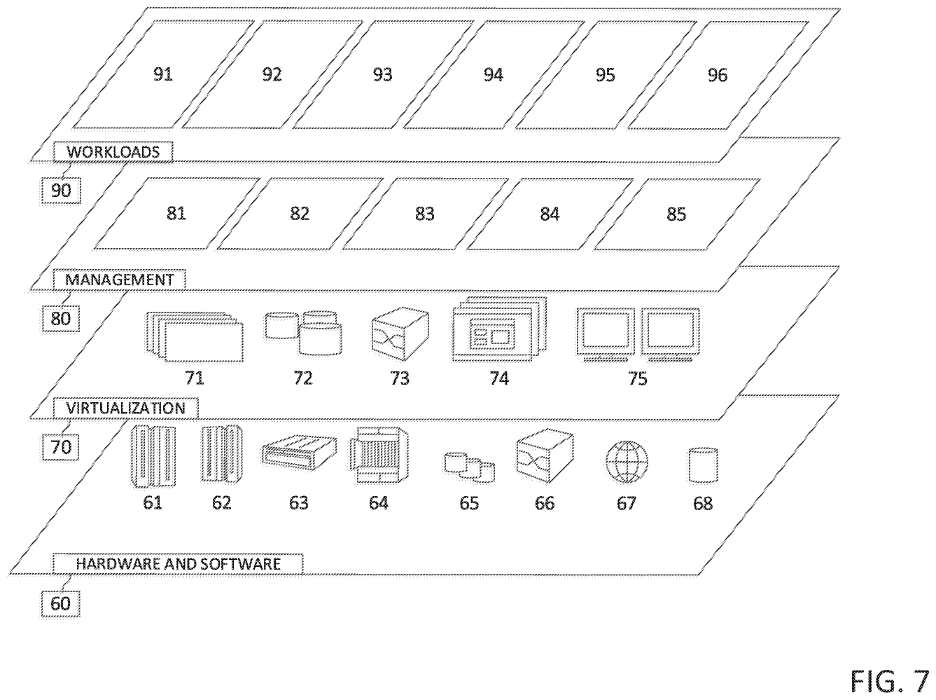

In exemplary embodiments, the computing device 110 may include a record matching client 112, one or more records 114, and one or more events 116, respectively, and may be an enterprise server, a laptop computer, a notebook, a tablet computer, a netbook computer, a personal computer (PC), a desktop computer, a server, a personal digital assistant (PDA), a smart phone, a mobile phone, a virtual device, a thin client, an IoT device, or any other electronic device or computing system capable of sending and receiving data to and from other computing devices. While the computing device 110 is shown as a single device, in other embodiments, the computing device 110 may be comprised of a cluster or plurality of computing devices, in a modular manner, etc., working together or working independently. The computing device 110 is described in greater detail as a hardware implementation with reference to FIG. 5, as part of a cloud implementation with reference to FIG. 6, and/or as utilizing functional abstraction layers for processing with reference to FIG. 7.

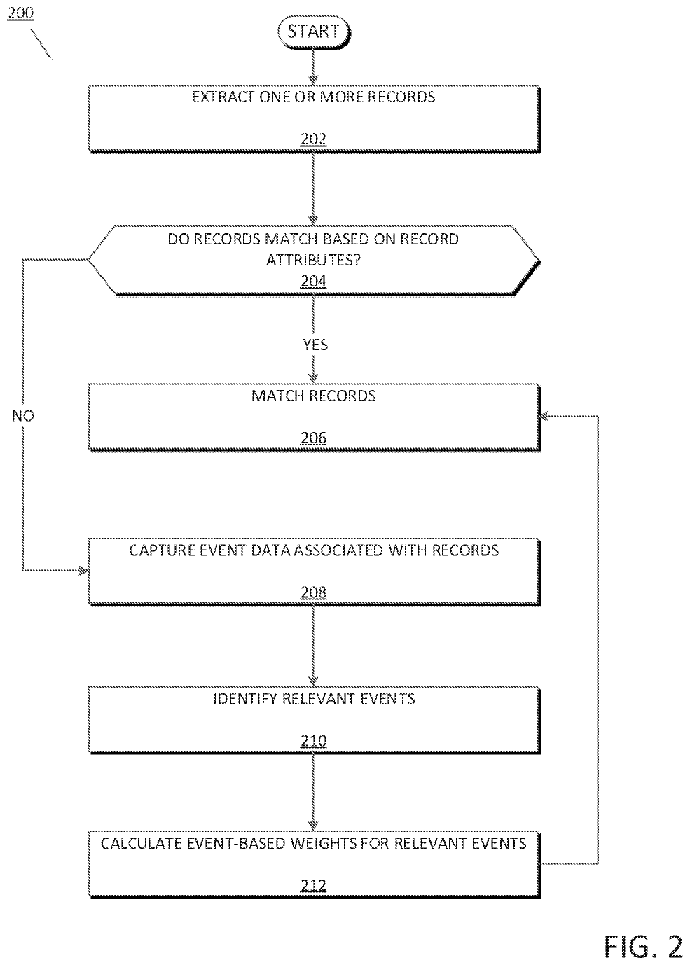

In exemplary embodiments, the record matching client 112 may act as a client in a client-server relationship with a server, e.g., the record matching server 120, and may be a software and/or hardware application capable of communicating with and providing a user interface for a user to interact with a server and other computing devices via the network 108. Moreover, in the example embodiment, the cognitive assessment client 112 may be capable of transferring data between the computing device 110 and other devices via the network 108. In embodiments, the cognitive assessment client 112 may utilize various wired and wireless connection protocols for data transmission and exchange, including Bluetooth, 2.4 GHz and 5 GHz internet, near-field communication, etc. The cognitive assessment client 112 is described in greater detail with respect to FIG. 2-7.

In exemplary embodiments, the one or more records 114 may represent one or more entities, and may describe such entities with one or more attributes such as name, address, location, identifier, phone, social media handles, purchase histories, credit card details, etc. In embodiments, the one or more records 114 may be extracted or received from one or more differing sources, and as such may conform to one or more different file formats, nomenclatures, etc. It will be appreciated by one skilled in the art that although the one or more records 114 may only be illustrated once in FIG. 1, the one or more records 114 may comprise any number of records extracted from any number of data sources. Some of the one or more records 114, for example, may be extracted from a wearable device while others may be extracted from a medical device. The one or more records 114 and the one or more records 114 may be collectively referred to herein as “the records.” The one or more records 114 are described in greater detail with respect to FIG. 2-7.

In exemplary embodiments, the one or more events 116 may describe an occurrence associated with one or more records 114. In embodiments, the one or more events 116 may describe a combination of time and physical location (latitude, longitude, address, etc.), time and digital location (phone call, web conference, etc.), a transaction (financial exchange, etc.), a contract (roles and timing of a contract, etc.), and the like. The one or more events 116 may have varying durations, e.g., from less than a second to years. In embodiments, the record matching program 122 may be configured to continuously check for new and/or updated occurrences of the one or more events 116, and they may be maintained by product/service providers, government entities, research institutions, universities, etc. The one or more events 116 may be collectively referred to herein as “the events.” The one or more events 116 are described in greater detail with respect to FIG. 2-7.

In exemplary embodiments, the record matching server 120 includes a record matching program 122, and may act as a server in a client-server relationship with a client, e.g., the record matching client 112. The record matching server 120 may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. While the record matching server 120 is shown as a single device, in other embodiments, the record matching server 120 may be comprised of a cluster or plurality of computing devices, in a modular manner, etc., working together or working independently. The record matching server 120 is described in greater detail as a hardware implementation with reference to FIG. 5, as part of a cloud implementation with reference to FIG. 6, and/or as utilizing functional abstraction layers for processing with reference to FIG. 7.

In embodiments, the record matching program 122 may be a software and/or hardware program that may extract one or more records and determine whether any of the records match based on record attribute-based scoring. Based on determining that the records match based on record attribute-based scoring, the record matching program 122 may match the records. Based on determining that the records do not match based on record attribute-based scoring, the record matching program 122 may capture event data associated with the records and identify relevant events therefrom. The record matching program 122 may further calculate event-based scores for the relevant events and match the records based on both the attribute-based scores and the event-based scores. The record matching program 122 is described in greater detail with reference to FIG. 2-7.

FIG. 2 depicts an exemplary flowchart 200 illustrating the operations of the record matching program 122 of the record matching system 100, in accordance with the exemplary embodiments.

The record matching program 122 may extract one or more records (step 202). In embodiments, the record matching program 122 may extract (or receive) one or more records corresponding to one or more entities via the network 108. In embodiments, the one or more records may be obtained from various sources in various non-analogous formats. Moreover, the records may be duplicative, meaning more than one record may exist for a single entity. In embodiments, the records may be described by one or more record attributes detailing, e.g., name, location, address, identifier, phone, email, social media handle, purchase history, etc., as well as one or more events detailing one or more occurrences associated with the record, e.g., a time and physical location (latitude, longitude, address, etc.), time and digital location (phone call, web conference, etc.), a transaction (financial exchange, etc.), a contract (roles and timing of a contract, etc.), and the like. In embodiments, the record matching program 122 may be configured to continuously check for new and/or updated records such that record matching can be done in real time. Such records may be maintained by product/service providers, government entities, research institutions, universities, etc. In embodiments, the records may be analysed for various purposes, e.g., research, healthcare, finance, marketing, etc., and thus deduplicating and completing the records to a greatest extent possible is desirable when duplicate records corresponding to a same entity may not match exactly.

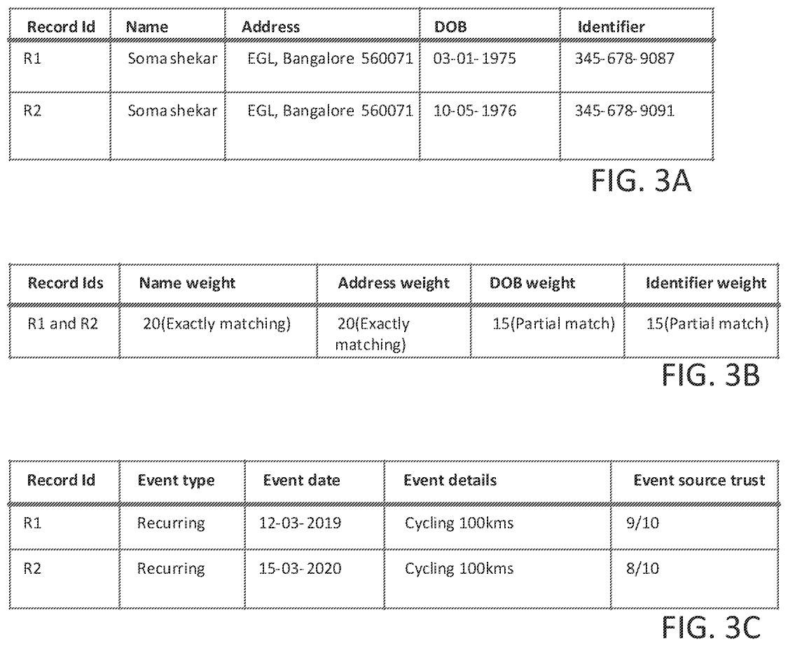

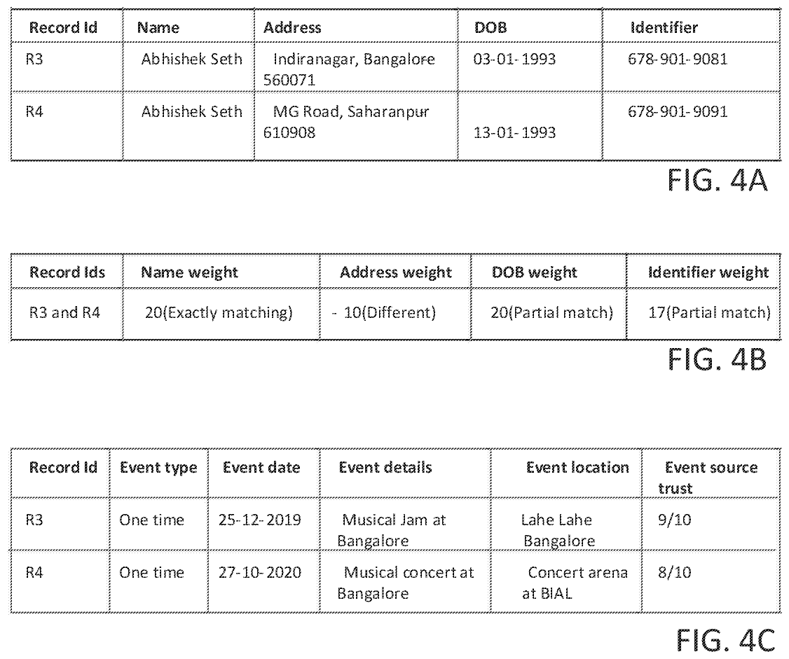

In order to better illustrate the operations of the record matching program 122, reference is now made to two mutually exclusive illustrative examples depicted by FIG. 3 and FIG. 4, respectively. In the examples, the record matching program 122 is tasked with determining whether two records should be matched, namely Record Ids R1 and R2 in FIG. 3A and Record Ids R3 and R4 in FIG. 4A.

The record matching program 122 may determine whether the one or more records match based on one or more record attributes (decision 204). In embodiments, the records may be associated with one or more attributes such as name, address, identifier, etc., and the record matching program 122 may determine whether two or more records can be matched based on comparing such record attributes. More specifically, the record matching program 122 may compare the record attributes using distance or similarity metrics, common data field models, etc., in order to determine whether two or more records detail a same entity. In embodiments, the record matching program 122 may require that the record attribute of one record match that of another record in entirety in order to be considered a match, i.e., 100%, while in other embodiments the record matching program 122 may implement a tolerance or threshold certainty to identify a match. In further embodiments, the record matching program 122 may compare two or more record attributes of a first record with those of a second record in order to perform a multi-attribute comparison, e.g., comparing two columns of a first record to two columns of a second record. The record matching program 122 may additionally use such techniques to validate a match based on a single record attribute comparison between records. In general, the record matching program 122 may utilize any suitable comparing technique to identify duplicate records that require matching. Based on the desired comparison of the record attributes, e.g., using a similarity metric, the record matching program 122 may output a confidence score indicating to what extent the record matching program 122 believes the records are a match. In embodiments, the record matching program 122 may compare the confidence score to a threshold in order to determine whether the record matching program 122 has sufficient confidence that the records correspond to a same entity and are in fact duplicative. For example, scores above a certain threshold may be automatically matched, while those below a threshold automatically discounted, and any scores between triggering clerical review.

Containing the aforementioned illustrative example, and now with additional reference to FIGS. 3B and 4B, the record matching program 122 calculates attribute-based scores based on the extent to which one or more record attributes of one record matches those of another with a maximum score of 20 and minimum score of −10. The scores for each record attribute are then cumulated and, if the total score exceeds 75, the records are matched, while clerical review is triggered for any scores less than a 75 and greater than a 40. Beginning with record Ids R1 and R2 within FIG. 3B, the record matching program 122 calculates a Name weight score of 20 (exact match), an Address Weight of 20 (exact match), a DOB weight of 15 (partial match), and an Identifier weight of 15 (partial match), totaling 70 points but failing to be automatically matched based on the threshold of 75. With reference now to Record Ids R3 and R4 within FIG. 4B, the record matching program 122 calculates a Name weight of 20 (exact match), an Address weight of −10 (no match), a DOB weight of 20 (exact match), and an Identifier weight of 17 (partial match), for a total of 47, thereby triggering clerical review.

If the record matching program 122 determines that the one or more records can be matched based on attributes (decision 204, “YES” branch), the record matching program 122 may match the records based thereon (step 206). In embodiments, the record matching program 122 may match the records by assigning a same entity ID to both of the matching records, thereby creating an association. In this way, any time the records for a particular entity are needed, one simply need reference the entity ID in order to pull all records associated therewith. Alternatively, the record matching program 122 may match the records by embedding within each record a pointer/link to the other, combining/overwriting the records, etc. In general, the record matching program 122 may utilize any suitable means for deduplicating records identified as being redundant.

If however the record matching program 122 determines that the one or more records cannot be matched based on attributes alone (decision 204, “NO” branch), the record matching program 122 may capture event data associated with the records (step 208). In embodiments, the record matching program 122 may capture event data associated with the two or more records in order to broaden and expand the data used in the matching process, and may do so by referencing an association between the one or more events 116 and the one or more records 114. In embodiments, the one or more events may detail at least one of a time and physical location (lat./long., address, etc.), time and digital location (phone call, web conference, etc.), a transaction (financial exchange, etc.), a contract (roles and timing of a contract, etc.), and the like. Such events may be captured by, e.g., user input (journal, logging, etc.), one or more devices (smart phone, exercise watch, etc.), fitness tracker, digital trace (log-in, GPS data, financial transaction, etc.), and the like. In embodiments, the record matching program 122 may be configured to continuously check for new and/or updated events, and the events may be maintained by product/service providers, government entities, research institutions, universities, etc. In embodiments, the record matching program 122 may require that the one or more events be obtained from a trustworthy source in order to be considered. For example, such sources may require vetting or an initial/periodic trustworthiness validation. Such trustworthiness may be represented by a normalized trustworthiness score, and the record matching program 122 may only consider events from sources having a trustworthiness that exceeds a threshold.

Continuing the previously introduced example, and with reference additionally to FIGS. 3C and 4C, the record matching program 122 captures event data from Record Ids R1, R2, R3, and R4, including Event Type, Event Date, Event Details, Event Location, and Event Source Trust.

The record matching program 122 may identify relevant events of the captured event data (step 210). In embodiments, the record matching program 122 may identify relevant events in order to reduce processing of less useful event data and focus on events that are found most useful in the record matching process. The record matching program 122 may then focus on analysing those relevant events and discard those found to have less efficacy. In an embodiment, the record matching program 122 may identify relevant events as simply as referencing a predefined list of event types associated with a record type. For example, the record matching program 122 may receive user input indicating that specific events are found to have most efficacy in the matching process of a particular data type. In more advanced embodiments, the record matching program 122 may be configured to identify relevant events based on machine learning techniques. For example, the record matching program 122 may be initially configured to compare all extracted event type data and utilize machine learning algorithms to determine whether the two or more records match based thereon (described in greater detail forthcoming). The record matching program 122 may then identify as relevant the one or more event types that contributed most to determining whether the records match. Such machine learning techniques may include regression, etc., and either of the described means of identifying relevant event data can be used and varied based on industry, business, user requirements, etc.

Referring again to the previously introduced example, and with reference to FIG. 3C and FIG. 4C, the record matching program 122 captures event data from Record Ids R1, R2, R3, and R4. As illustrated by FIG. 3C, each of Record Id R1 and R2 detail recurring Cycling events of 100 kms from sources having a trust level of 9/10 and 8/10, respectively. In addition, and with reference to FIG. 4C, the record matching program 122 captures a one-time event from Record Id R3 detailing a Musical Jam at Bangalore from a source having a trust level of 9/10, as well as a one-time event from Record Id R4 detailing a Musical concert at Bangalore from a source having a trust level of 8/10.

The record matching program 122 may calculate event-based weights for the relevant events (step 212). In embodiments, the record matching program 122 may utilize comparison functions, such as distance/similarity metrics, in order to determine a similarity of a pair of relevant events (e.g., applied to values/strings/dates/etc.). The record matching program 122 may then associate a weight to each outcome, e.g., start with some default set of weights (positive/negative) based on event characteristics until the weights are learned via machine learning over a period of time and while discarding events that are found not to contribute to improving match accuracy. The record matching program 122 may then sum the weights into an event-based score for incorporation into the record matching determination, for example determining a match based solely on the event-based score or in combination with the attribute-based score computed above (described in greater detail forthcoming).

Continuing the previously introduced example, and with reference to FIG. 3C, the record matching program 122 calculates an event weight of 10 based on determining that the 100 kms cycling events of each of records R1 and R2 match, increasing the total score to 80 when summed with the attribute-based score. In addition, and with reference to FIG. 4C, the record matching program 122 calculates an event weight of 10 based on the one time musical events at Bangalore matching, bringing the total score to 57 when summed with the attribute-based score.

The record matching program 122 may match the records (step 206). In embodiments wherein event-based scores are calculated, the record matching program 122 may match the records based on the event-based scoring solely or in combination with the attribute-based scoring. As previously described, the record matching program 122 may implement thresholds for comparison when determining whether to match records, as well as seek clerical review. In a similar manner to above and based on the event-based and/or attribute-based scores, if the record matching program 122 determines with sufficient confidence that the records match, the record matching program 122 may assign a same record ID to each of the matching records, thereby associating the two records.

Concluding the previously introduced example, and with continued reference to FIG. 3-4, the record matching program 122 determines that records R1 and R2 likely correspond to a same entity based on the total score of 80 exceeding the match threshold of 75. In addition, the record matching program 122 determines that records R1 and R2 may correspond to a same entity, however will flag this comparison for administrative review as the total score of 57 falls between 40 and 75. Moreover, the record matching program 122 will make the event-based matching information available to a data steward, as well as learn from actions taken by the data steward in order to perform such actions autonomously in the future without the need for data steward intervention. For example, the record matching program 122 may monitor and learn from the activity and decisions of the data steward in order to automate those decisions in the future when conditions are sufficiently similar.

FIG. 3-4 depict example use cases of the record matching program 122, in accordance with the exemplary embodiments.

FIG. 5 depicts a block diagram of devices used within the record matching system 100 of FIG. 1, in accordance with the exemplary embodiments. It should be appreciated that FIG. 5 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 40 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfilment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and record matching processing 96.

The exemplary embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for event-based record matching, the method comprising:
extracting one or more events from a first record and a second record;
calculating an event-based score based on comparing the one or more events extracted from the first record with the one or more events extracted from the second record; and
matching the first record to the second record based on the event-based score exceeding a threshold.

2. The method of claim 1, wherein extracting the one or more events from the first record and the second record is in response to determining that an attribute-based score fails to exceed the threshold, and wherein the attribute-based score is computed by comparing one or more attributes of the first record with one or more attributes of the second record.

3. The method of claim 2, further comprising generating a combined score based on the attribute-based score and the event-based score, and wherein matching the first record to the second record is further based on the combined score.

4. The method of claim 1, wherein matching the first record to the second record further comprises assigning a same unique identifier to the first record and the second record.

5. The method of claim 1, further comprising:
receiving feedback indicating an accuracy of the matching.

6. The method of claim 1,
identifying one or more event types of the one or more events that contributed most to the matching of the first record to the second record, and wherein calculating the event-based score is based on comparing the one or more event types extracted from the first record with the one or more event types extracted from the second record.

7. The method of claim 1, wherein the one or more events may be selected from a group consisting of a time and a physical location, the time and a digital location, and a transaction.

8. A computer program product for event-based record matching comprising a computer-readable tangible storage device having program code embodied therewith, the program code executable by a processor of a computer to perform a method, the method comprising:
extracting one or more events from a first record and a second record;
calculating an event-based score based on comparing the one or more events extracted from the first record with the one or more events extracted from the second record; and
matching the first record to the second record based on the event-based score exceeding a threshold.

9. The computer program product of claim 8, wherein extracting the one or more events from the first record and the second record is in response to determining that an attribute-based score fails to exceed the threshold, and wherein the attribute-based score is computed by comparing one or more attributes of the first record with one or more attributes of the second record.

10. The computer program product of claim 9, further comprising generating a combined score based on the attribute-based score and the event-based score, and wherein matching the first record to the second record is further based on the combined score.

11. The computer program product of claim 8, wherein matching the first record to the second record further comprises assigning a same unique identifier to the first record and the second record.

12. The computer program product of claim 8, further comprising:
receiving feedback indicating an accuracy of the matching.

13. The computer program product of claim 8,
identifying one or more event types of the one or more events that contributed most to the matching of the first record to the second record, and wherein calculating the event-based score is based on comparing the one or more event types extracted from the first record with the one or more event types extracted from the second record.

14. The computer program product of claim 8, wherein the one or more events may be selected from a group consisting of a time and a physical location, the time and a digital location, and a transaction.

15. A computer system for event-based record matching comprising one or more computer devices each having one or more processors and one or more tangible storage devices; and
a program embodied on at least one of the one or more storage devices, the program having a plurality of program instructions for execution by the one or more processors, the program instructions comprising instructions for:
extracting one or more events from a first record and a second record;
calculating an event-based score based on comparing the one or more events extracted from the first record with the one or more events extracted from the second record; and
matching the first record to the second record based on the event-based score exceeding a threshold.

16. The computer system of claim 15, wherein extracting the one or more events from the first record and the second record is in response to determining that an attribute-based score fails to exceed the threshold, and wherein the attribute-based score is computed by comparing one or more attributes of the first record with one or more attributes of the second record.

17. The computer system of claim 16, further comprising generating a combined score based on the attribute-based score and the event-based score, and wherein matching the first record to the second record is further based on the combined score.

18. The computer system of claim 15, wherein matching the first record to the second record further comprises assigning a same unique identifier to the first record and the second record.

19. The computer system of claim 15, further comprising:
receiving feedback indicating an accuracy of the matching.

20. The computer system of claim 15,
identifying one or more event types of the one or more events that contributed most to the matching of the first record to the second record, and wherein calculating the event-based score is based on comparing the one or more event types extracted from the first record with the one or more event types extracted from the second record.
